(19) United States
(12) Patent Application Publication
(10) Pub. No.: US 2017/0221021 A1
(43) Pub. Date: Aug. 3, 2017

(54) METHOD AND SYSTEM FOR DIGITAL CURRENCY CREATION AND MARKETING

(71) Applicants: Rafael GAZETOV, Visaginas (LT); Marina SARIPOVA, Visaginas (LT); Andrejus SILINAS, Vilnius (LT)

(72) Inventors: Rafael GAZETOV, Visaginas (LT); Marina SARIPOVA, Visaginas (LT); Andrejus SILINAS, Vilnius (LT)

(21) Appl. No.: 15/010,019

(22) Filed: Jan. 29, 2016

(51) Int. Cl. G06Q 20/06

(52) U.S. Cl. CPC G06Q 20/065

(57) ABSTRACT

A method and system which allow an actor/user to create new cryptocurrency, designed to motivate people to an active lifestyle in various fields by making certain activities or actions, which can be measured and verified using smartphones or other telecommunication devices. The method creates two kinds of universal cryptocurrency, namely: cryptocurrency/time, based on a time during which the activities or actions were performed and cryptocurrency/quantity, based on the amount/quantity of performed activities or actions. The method converts amount of time during which activities/actions were performed into the cryptocurrency/time and also converts amount of activities/actions which were performed into the cryptocurrency/quantity. Thus, a cryptocurrency/time and a cryptocurrency/quantity are parts of a new single digital currency under the preliminary name: “CRYPTonFly” as the abbreviation of words “creation cryptocurrency on the fly”, which empowers each individual a freedom and ability to make money converting certain activities and actions into the digital currency.

### FIELD OF THE INVENTION

The present invention relates to a methods and systems for digital currency creation in which encryption techniques are used to regulate the generation of units of currency and verify the transfer of funds, operating independently of a central bank.

The present invention relates to a new generation of digital currency which appeared at the junction of the Internet, telecommunications technologies and certain activities or actions of human predominantly in the following fields: Internet, telecommunications, banking, financial and stock markets, exchanges, insurance, advertising, sport and fitness, tourism, travel, ecology, science and technologies, medicine, arts, entertainment, Internet trading, industry and other fields.

### BACKGROUND

Decentralized cryptocurrency is produced by the entire cryptocurrency system collectively, at a rate which is defined when the system is created and which is publicly known. In centralized banking and economic systems such as the Federal Reserve System, corporate boards or governments control the supply of currency by printing units of fiat money or demanding additions to digital banking ledgers. However, companies or governments cannot produce units of cryptocurrency and as such, have not so far provided backing for other firms, banks or corporate entities which hold asset value measured in a decentralized cryptocurrency. The underlying technical system upon which decentralized cryptocurrencies are based was created by the group or individual known as Satoshi Nakamoto.

As of March 2015, hundreds of cryptocurrency specifications exist; most are similar to and derived from the first fully implemented decentralized cryptocurrency. Within cryptocurrency systems the safety, integrity and balance of ledgers is maintained by a community of mutually distrustful parties referred to as miners: members of the general public using their computers to help validate and timestamp transactions adding them to the ledger in accordance with a particular timestamping scheme. The security of cryptocurrency ledgers is based on the assumption that the majority of miners are honestly trying to maintain the ledger, having financial incentive to do so.
However, mining of existing cryptocurrencies, for example bitcoin, is very expensive and requires a lot of computing power and electricity, and also completely controlled by just a handful of people. At the same time, more than 50% of blockchain hashpower actually is controlled by two representatives of Chinese bitcoin miners. This is a main problem and a major obstacle to their wide distribution.

### SUMMARY OF THE INVENTION

The present invention relates to a new generation of digital currency which appeared at the junction of the Internet, telecommunications technologies and certain activities or actions of human.

The present invention reveals both a method and a system which allows to actor/user to create cryptocurrency by making certain activities or actions, which can be authentic measured and verified using smartphone or other telecommunication devices.

The present invention allows to create two kind of universal cryptocurrency, namely: cryptocurrency/time, based on a time during which the activities or actions were performed and cryptocurrency/quantity, based on the amount/quantity of performed activities or actions.

Thus, the present invention converts amount of a time during which activities or actions were performed into the cryptocurrency/time and also converts amount of activities or actions which were performed into the cryptocurrency/quantity.

The present invention comprises: identification of actor/user; making certain activities or actions by the actor/user; the achievement of certain amount of a time during which were performed activities or actions; the achievement of certain amount/quantity of performed activities or actions; authentic measurement and verification of amount of a time during which were performed activities or actions; authentic measurement and verification of the amount/quantity of performed activities or actions; the calculation and charging of cryptocurrency/time based on a lime during which the activities or actions were performed to the personal wallet or account of the actor/user; the calculation and charging of cryptocurrency/quantity based on amount/quantity of performed activities or actions to the personal wallet or account of the actor/user.

In accordance with the invention, creation of cryptocurrency/time, based on a time during which the activities or actions were performed, includes: identification of actor/user; making certain activities or actions by the actor/user; the achievement of certain amount of a time during which the activities or actions were performed; authentic measurement and verification of amount of a time during which the activities or actions were performed; the calculation and charging of cryptocurrency/time to the personal wallet or account of the actor/user;

In accordance with the invention, creation of cryptocurrency/quantity, based on the amount/quantity of performed activities or actions, includes: identification of actor/user, making certain activities or actions by the actor/user; the achievement of certain amount/quantity of performed activities or actions; authentic measurement and verification of amount/quantity of performed activities or actions; the calculation and charging of cryptocurrency/quantity to the personal wallet or account of the actor/user;

In accordance with the invention, system for digital currency creation includes: telecommunication devices and a special mobile application; identification, authentic measurement and verification of amount of a time during which the certain activities or actions were performed using telecommunication devices; identification, authentic measurement and verification of amount/quantity of performed certain activities or actions using telecommunication devices; the calculation and charging of cryptocurrency/time to the personal. wallet or account of the actor/user in accordance with a measured and verified amount of a time during which the activities or actions were performed; the calculation and charging of cryptocurrency/quantity to the personal wallet or account of the actor/user in accordance with a measured and verified amount/quantity of activities or actions;

In the present invention, the actor/user making certain activities or actions in the process of marketing of cryptocurrency/time or cryptocurrency/quantity which leads to the creation of a new cycle of creation of a cryptocurrency/time or a cryptocurrency/quantity.

### A BRIEF DESCRIPTION OF THE DRAWING

FIG. 1 is a drawing illustrating the main operation stages of the method and system for digital currency creation and marketing.

### A DESCRIPTION OF THE PREFERRED EMBODIMENT

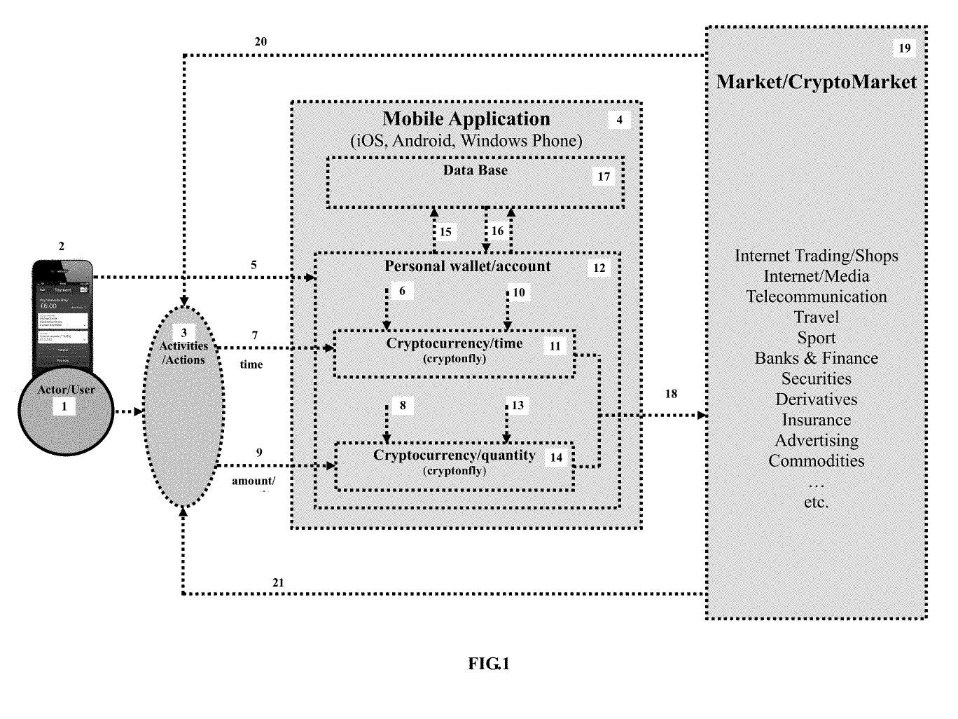

Next, the embodiment of the presented invention—the method and system for cryptocurrency creation and marketing,—illustrated in the accompanying drawing (FIG. 1), will be described.

FIG. 1 is a drawing illustrating the main operation stages of the method where the actor/user [1] using own smartphone or other telecommunication devices [2] making certain activities or actions [3]; further, a special mobile application [4] using own smartphone or other telecommunication devices performs identification [5] of the actor/user; further, a special mobile application performs authentic measurement and verification [6] of a time [7] during which were performed activities or actions; further, a special mobile application performs authentic measurement and verification [8] of amount/quantity [9] of performed activities or actions; further, a special mobile application performs calculation and charging [10] of cryptocurrency/time [11] to the personal wallet or account [12] of the actor/user; further, a special mobile application performs calculation and charging [13] of cryptocurrency/quantity [14] to the personal wallet or account of the actor/user; further, the mobile application performs storing [15] and exchange [16] of all data and accounts of actor/user and their performed actions in the database [17]; further, actor/user performs marketing [18] of the created cryptocurrency/time or cryptency/quantity on the market [19]; further, the marketing process of cryptocurrency accompanied by certain activities or actions [20], which lead to a new cycle of creation of a cryptocurrency/time; further, the marketing process of cryptocurrency accompanied by certain activities or actions [21], which lead to a new cycle of creation of a cryptocurrency/quantity.

### CONCLUSION

The core of the presented invention is a newly developed method and system with Application that allows people to earn new cryptocurrency almost in all spheres of human life and activities, that allows involve leading companies working in the sphere of Internet and telecommunications, companies of banking and financial sector, companies of industrial sector and other sectors. Newly developed method and system allows to perform flexible and unlimited emission of cryptocurrency.

Within nearest 15 years will be radically changed the banking system and also the main principles of the existence of money. Cryptocurrencies development will lead to the fact that the states will loose the monopoly on the emission of financial instruments. The key to the new cryptocurrencies development will be smartphones. <<But in the next 15 years, digital banking will give the poor more control over their assets and help them transform their lives. The key to this will be mobile phones.>> (Melinda and Bill Gates, Annual Letter).

### EXAMPLES OF CRYPTOCURRENCIES

Examples of two kinds of universal cryptocurrency, namely: cryptocurrency/time, based on a time during which the activities or actions were performed and cryptocurrency/quantity, based on the amount/quantity of performed activities or actions.

A cryptocurrency/time and a cryptocurrency/quantity are parts of a new single digital currency under the preliminary name “CRYPTonFly”, as the abbreviation of words “creation cryptocurrency on the fly”, empowers each individual a freedom and ability to make money by converting certain activities and actions into the digital currency.

In the mentioned below examples, 1 cryptonfly conventionally assumed equal to $1 US.

### EXAMPLES OF CRYPTOCURRENCY/TIME

As example in IT sphere, the calculation and charging of cryptocurrency/time to the personal wallet or account of the user is performed for a certain amount of time spent by the user on the Internet. For example, for every 30 minutes spent by user on the Internet, the user gets 1 cryptonfly$.

As example in telecommunication sphere, the calculation and charging of cryptocurrency/time to the personal wallet or account of the user is performed for a certain amount of time spent by the user for conversations by the smartphone or other telecommunication devices. For example, for every 30 minutes of conversation by the smartphone, the user gets 1 cryptonfly$.

As example in travel sphere, the calculation and charging of cryptocurrency/time to the personal wallet or account of the passenger/user is performed for a certain amount of time spent during travel on certain transport. For example, for every hour spent by the passenger/user in flight on the aircraft, the passenger/user gets 1 cryptonfly$.

As example in sport sphere, the calculation and charging of cryptocurrency/time to the personal wallet or account of the user is performed for a certain amount of time spent in sports and fitness centers, swimming pools, etc. For example, for every hour spent in the fitness center, the user gets 1 cryptonfly$.

### EXAMPLES OF CRYPTOCURRENCY/QUANTITY

As example in Internet/Media sphere, the calculation and charging of cryptocurrency/quantity to the personal wallet or account of the user is performed for a certain amount of views of multimedia content (video, photos, text). For example, for every 100 views of video, the user gets 1 cryptonfly$.

As example in sphere of Internet trading, the calculation and charging of cryptocurrency/quantity to the personal wallet or account of the user is performed for a certain amount of money spent on purchases in the internet shops. For example, for every $100 spent on purchases in the Internet shop, the user gets 1 cryptonfly$.

As example in sphere of advertising, the calculation and charging of cryptocurrency/quantity to the personal wallet or account of the user is performed for a certain amount of views of advertisement (video, photos, text). For example, for every 100 views of advertisement (video), the user gets 1 cryptonfly$.

As example in sphere of money, the calculation and charging of cryptocurrency/quantity to the personal wallet or account of the user is performed for a certain amount of money placed in hank account. For example, for every $1,000 placed in a bank account as a deposit, the user gets 1 cyptonfly$.

As example in sphere of Forex, the calculation and charging of cryptocurrency/quantity to the personal wallet or account of the user is performed for a certain amount of currency bought or sold on the currency exchange market. For example, for every $1,000 bought on the Forex, the user gets 1 cryptonfly$.

As example in sphere of securities, the calculation and charging of cryptocurrency/quantity to the personal wallet or account of the issuer is performed for a certain amount of securities issued by the issuer and placed in different markets. For example, for every 100 securities with par value of $1 placed on the stock market, the issuer gets 1 cryptonfly$.

As example in sphere of securities, the calculation and charging of cryptocurrency/quantity to the personal wallet or account of the user is performed for a certain amount of securities bought by the user on the markets or exchanges. For example, for every 100 securities with par value of $1 bought on the stock market, the user gets 1 cryptonfly$.

As example in sphere of securities, the calculation and charging of cryptocurrency/quantity to the personal wallet or account of the user is performed for a certain amount of money spent by the user for the purchase of securities. For example, for every $1,000 spent for the purchase of securities on the stock market, the user gets 1 cryptonfly$,

As example in sphere of derivatives, the calculation and charging of cryptocurrency/quantity to the personal wallet or account of the user is performed for a certain amount of derivatives bought by the user on the markets or stock exchanges. For example, for each futures, which is valued at $100 and bought on the stock market, the user gets 1 cryptonfly$.

As example in sphere of derivatives, the calculation and charging of cryptocurrency/quantity to the personal wallet or account of the user is performed for a certain amount of money spent by the user for the purchase of derivatives. For example, for every $1,000 spent for the purchase of derivatives on the stock market, the user gets 1 cryptonfly$.

As example in sphere of insurance, the calculation and charging of cryptocurrency/quantity to the personal wallet or account of the user is performed for a certain amount of money spent by the user for the purchase of an insurance policy. For example, for every $1,000 spent for the purchase of an insurance policy, the user gets 1 cryptonfly$.

As example in sphere of commodities, the calculation and charging of cryptocurrency/quantity to the personal wallet or account of the user is performed for a certain amount of commodities bought or sold on the market. For example, for every 1 gram of gold bought on the stock exchange or market, the user gets 1 cryptonfly$.

1. A method and system for digital currency creation and marketing, the method comprising: identification of actor/user; making certain activities or actions by the actor/user; the achievement of certain amount of a time during which were performed activities or actions; the achievement of certain amount/quantity of performed activities or actions; authentic measurement and verification of amount of a time during which were performed activities or actions; authentic measurement and verification of the amount/quantity of performed activities or actions; the calculation and charging of cryptocurrency/time based on a time during which the activities or actions were performed to the personal wallet or account of the actor/user; the calculation and charging of cryptocurrency/quantity based on amount/quantity of performed activities or actions to the personal wallet or account of the actor/user.

2. The method according to claim 1, wherein creation of cryptocurrency/time, based on a time during which the activities or actions were performed, includes: identification of actor/user; making certain activities or actions by the actor/user; the achievement of certain amount of a time during which the activities or actions were performed; authentic measurement and verification of amount of a time during which the activities or actions were performed; the calculation and charging of cryptocurrency/time to the personal wallet or account of the actor/user.

3. The method according to claim 1, wherein creation of cryptocurrency/quantity, based on the amount/quantity of performed activities or actions, includes: identification of actor/user; making certain activities or actions by the actor/user; the achievement of certain amount/quantity of performed activities or actions; authentic measurement and verification of amount/quantity of performed activities or actions; the calculation and charging of cryptocurrency/quantity to the personal wallet or account of the actor/user.

4. A method and system for digital currency creation and marketing, the system comprising: telecommunication devices and a special mobile application; identification, authentic measurement and verification of amount of a time during which the certain activities Or actions were performed using telecommunication devices; identification, authentic measurement and verification of amount/quantity of performed certain activities or actions using telecommunication devices; the calculation and charging of cryptocurrency/time to the personal wallet or account of the actor/user in accordance with a measured and verified amount of a time during which the activities or actions were performed; the calculation and charging of cryptocurrency/quantity to the personal wallet or account of the actor/user in accordance with a measured and verified amount/quantity of activities or actions.
